(19) United States
(12) Patent Application Publication
(10) Pub. No.: US 2019/0242768 A1
(43) Pub. Date: Aug. 8, 2019

(54) Force and Moment Sensor, Force Transducer Module for Such a Force and Moment Sensor and Robot Comprising Such a Force and Moment Sensor

(71) Applicant: Kistler Holding AG, Winterthur (CH)

(72) Inventors: Christof Sonderegger, Frauenfeld (CH); Simon Eichmann, Turbenthal (CH)

(21) Appl. No.: 16/342,646

(22) PCT Filed: Oct. 5, 2017
(86) PCT No.: PCT/EP2017/075296

§ 371 Date: Apr. 17, 2019

(30) Foreign Application Priority Data
Oct. 17, 2016 (EP) 16194160.4

(51) Int. Cl. G01L 5/16; G01L 5/22; G05D 15/01; G05D 17/02

(52) U.S. Cl. CPC G01L 5/167; G05D 17/02; G05D 15/01; G01L 5/226

(57) ABSTRACT

A force and moment sensor includes four piezoelectric force transducers, an evaluation unit, a base plate and a cover plate. The base plate and the cover plate are mechanically connected to form a housing. The base plate defines a cavity in which the piezoelectric force transducers and the evaluation unit are arranged. The cover plate defines a delimiting surface on which the force to be detected acts. The four piezoelectric force transducers generate measurement signals for the detected force. The evaluation unit evaluates the measurement signals of the piezoelectric force sensors.

### TECHNICAL FIELD

The invention relates to a force transducer module, a force and moment sensor that includes such a force transducer module, and a robot that includes such a force and moment sensor.

### PRIOR ART

Robotics is a mega trend. Robots increasingly perform complex processes such as joining of components. Sensor technology is essential for measuring a joining force. A triaxial joining force is described by six components of a force and a moment. Such a joining force can be determined by a force and moment sensor. For this purpose, the force and moment sensor is arranged in the force path between a tool and a robot arm of the robot, for example in a wrist of the robot arm. The force and moment sensor detects the joining force and transmits output signals equivalent to the detected joining force via an interface of a bus system to a robot control of the robot.

The document US2016/0109311A1, which is hereby incorporated herein by this reference for all purposes, discloses a force and moment sensor for detecting a force. Four piezoelectric force transducers are mechanically fastened at four lateral surfaces of a square-shaped base plate. The piezoelectric force transducers are mechanically prestressed with a prestressing force against delimiting surfaces of a first and second support; an effective direction of the prestressing force is perpendicular to the delimiting surfaces. Each piezoelectric force transducer is arranged at the same distance to a reference point in the center of the base plate. Two piezoelectric force sensors are on an axis, respectively. The two axes are normal to the lateral surfaces of the base plate and extend at a right angle to each other. A first support is secured to the piezoelectric force transducers of the first axis and a second support is secured to the piezoelectric force transducers of the second axis.

The four piezoelectric force transducers detect three components of the force acting on the delimiting surfaces of the first and second support. From the known distance between the four piezoelectric force transducers and the reference point, three components of a moment acting on the base plate in the coordinate system can be calculated. Thus, the force and moment sensor provides a total of six components.

Each piezoelectric force transducer comprises three piezoelectric transducer elements. The piezoelectric transducer elements are arranged in such a crystallographic orientation that a force acting thereon generates electrical polarization charges in a quantity that is proportional to the magnitude of the force. For each piezoelectric force transducer, one piezoelectric transducer element detects the component of a normal force and two piezoelectric transducer elements detect two components of shear forces. Thus, for a detected force the four force transducers generate measurement signals in the form of electrical polarization charges. Each piezoelectric force transducer comprises a charge amplifier and an analog-to-digital converter. Each charge amplifier amplifies the electrical polarization charges of one of the three piezoelectric transducer elements and each analog-to-digital converter converts one of the three amplified electrical polarization charges resulting in a total of three digital output signals. Thus, twelve digital output signals are generated for a total of twelve piezoelectric transducer elements.

The document DE102012005555B3 teaches a measuring plate comprising a plurality of piezoelectric force transducers arranged in a row. A pressure piece is associated with each piezoelectric force transducer; the force to be detected acts on the piezoelectric force transducers via the pressure pieces. Each piezoelectric force transducer comprises two piezoelectric transducer elements, one piezoelectric transducer element for detecting a compression force and one piezoelectric transducer element for detecting a shear force. The piezoelectric transducer elements of each of the piezoelectric force transducers are arranged in recesses of the measuring plate in pairs one on top of the other. A total of eight piezoelectric transducer elements generate eight measurement signals which are transmitted via electrical connections to four connectors. Signal cables can be connected with the connectors in order to transmit the measurement signals to an external evaluation unit.

### BRIEF OBJECTS AND SUMMARY OF THE INVENTION

It is a first object of the present invention to further develop such a force and moment sensor so that it has an as small spatial extension as possible for arrangement in the wrist of the robot arm without interfering with complex operations to be performed by the robot. A second object of the force and moment sensor is that it shall be as mechanically robust as possible and in particular have a high robustness for bending moments. Another object of the force and moment sensor is that it shall be as inexpensive as possible so as to contribute to the manufacturing costs of the robot only to a small extent. Yet another object of the force and moment sensor is to ensure a high level of occupational safety so that the robot and a person can work in the same space.

At least one of these objects is achieved by the features described hereinafter.

The invention relates to a force and moment sensor comprising four piezoelectric force transducers and a base plate; wherein the four piezoelectric force transducers detect a force and generate measurement signals for a detected force; wherein the force and moment sensor comprises a cover plate, which cover plate comprises a delimiting surface, on which delimiting surface the force to be detected acts; wherein the force and moment sensor comprises an evaluation unit, which evaluation unit analyzes measurement signals of the piezoelectric force transducers; wherein the base plate comprises at least one chamber for accommodating the piezoelectric force transducers and the evaluation unit, in which chamber the piezoelectric force transducers and the evaluation unit are arranged; and wherein the base plate and cover plate are mechanically connected to form a housing.

In contrast to the document US2016/0109311A1, the force and moment sensor according to the present invention accommodates four piezoelectric force transducers and also an evaluation unit for evaluating the measurement signals of the piezoelectric force transducers in a chamber of a base plate. Furthermore, the force to be detected acts on a delimiting surface of a cover plate. Therefore, only two components, a base plate and a cover plate, are needed for accommodating the piezoelectric force transducers and for application of the force. Base plate and cover plate are connected to form a housing. According to document US2016/0109311A1, this requires two supports and one base plate, according to document DE102012005555B3 this requires a measuring plate and four pressure pieces. This spatially compact arrangement of the piezoelectric force transducers and the evaluation unit in a chamber of the base plate as well as the introduction of the force at the delimiting surface of the cover plate leads to a significant size reduction of the force and moment sensor.

In one embodiment of the invention each piezoelectric force transducer comprises a plurality of piezoelectric transducer elements; that each piezoelectric force transducer detects exactly one component of a normal force by at least one first piezoelectric transducer element; and that each piezoelectric force transducer detects exactly one component of a shear force by at least one second piezoelectric transducer element.

Also in contrast to document US2016/0109311A1, the force and moment sensor according to the present invention comprises only eight piezoelectric transducer elements. This is a reduction of 33.3% in the number of piezoelectric transducer elements. However, the force and moment sensor is also able to detect three components of a force and three components of a moment. Reducing the number of piezoelectric transducer elements leads to a further reduction in size of the force and moment sensor. Moreover, the manufacturing costs of the force and moment sensor are dramatically reduced.

The invention also relates to a force transducer module for the force and moment sensor wherein the force transducer module is formed by four piezoelectric force transducers which are electrically contacted via electrical conductors with an evaluation unit.

The force transducer module according to the invention combines force detection, measurement signal generation and measurement signal evaluation functions. It has small dimensions and can be arranged in the chamber of the base plate of the force and moment sensor. As a result, the production of this force and moment sensor is particularly cost-effective since once the force transducer module is arranged in the chamber it is only necessary to mechanically connect the base plate and the cover plate to form a housing.

Furthermore, the present invention also relates to a robot comprising such a force and moment sensor wherein a delimiting surface of a base plate of the force and moment sensor is mechanically connected to a surface of a wrist of the robot; and wherein the delimiting surface of the cover plate of the force and moment sensor is mechanically connected to a tool.

In one embodiment of the invention each piezoelectric force transducer is mechanically prestressed with a prestressing force against the delimiting surface of the cover plate, wherein an effective direction of the prestressing force is normal to the delimiting surface; and wherein a bending moment of the tool acts as a normal force on the piezoelectric force transducers.

This is also in contrast to document US2016/0109311A1 in which the piezoelectric force transducers are mechanically prestressed with a prestressing force against the delimiting surfaces of the first and second support, the effective direction of this prestressing force being perpendicular to the delimiting surfaces. In this case, a bending moment of a tool will act on the piezoelectric force transducers as a shear force. The shear force is transmitted from the delimiting surfaces to the piezoelectric force transducers as a frictional force. For the transmission of the frictional force it is necessary to mechanically prestress the piezoelectric force transducers against the delimiting surfaces with a relatively high prestressing force. However, the piezoelectric material of the piezoelectric force transducer will only endure the prestressing force up to a breaking limit, above which breaking limit damage and breakage of the piezoelectric material will occur. In the present invention it is not necessary to apply such a high prestressing force because the bending moment of the tool acts as a normal force that extends parallel to the prestressing force. Therefore, it is not necessary to mechanically prestress the force and moment sensor according to the present invention with a high prestressing force whereby it can withstand significantly higher bending moments.

In one embodiment of the present invention, the force and moment sensor of the robot comprises two force transducer modules; wherein first piezoelectric force transducers of a first force transducer module detect a force a first time and generate first measurement signals for the force detected a first time; and wherein second piezoelectric force transducers of a second force transducer module detect the same force a second time and generate second measurement signals for the force detected a second time.

In one embodiment of the invention, the force and moment sensor of the robot comprises two force transducer modules; wherein a first evaluation unit of a first force transducer module evaluates the first measurement signals and provides them as first digital output signals; wherein a second evaluation unit of a second force transducer module evaluates second measurement signals and provides them as second digital output signals; wherein the force and moment sensor transmits the first digital output signals via a bus system to a robot control of the robot; wherein the force and moment sensor transmits the second digital output signals via the bus system to the robot control of the robot; and wherein the robot control of the robot compares the transmitted first digital output signals to the transmitted second digital output signals.

This is advantageous. Such a comparison according to the invention of digital output signals of a force detected twice may be necessary for reasons of work safety, in particular when the robot and a person work together in the same space and are not spatially separated from each other by safety measures such as a safety fence. In this case, humans are at a risk of serious or even fatal injury due to the rapid and powerful movements of the robot arm. The robot control of the robot compares the detected and transmitted forces and once it detects a difference between the two detected and transmitted forces it may switch the robot into a safety mode in which the collaboration of robot and person is interrupted and the person may move to a safe distance.

### BRIEF DESCRIPTION OF THE DRAWINGS

In the following, the invention will be explained by way of example with reference to the figures in which

FIG. 1 is an exploded view of a portion of a first embodiment of a force and moment sensor comprising one force transducer module;

FIG. 2 is an exploded view of a portion of a second embodiment of a force and moment sensor comprising two force transducer modules;

FIG. 3 shows a cross section through a portion of the second embodiment of a force and moment sensor according to FIG. 2;

FIG. 4 shows a plan view of a portion of an embodiment of a force transducer module for the force and moment sensor according to FIG. 1 or 2;

FIG. 5 is a view of a portion of the embodiment of the force transducer module according to FIG. 4, and

FIG. 6 shows a view of a portion of an embodiment of a robot comprising the force and moment sensor according to FIG. 1 or 2.

### DESCRIPTION OF EXEMPLARY EMBODIMENTS OF THE INVENTION

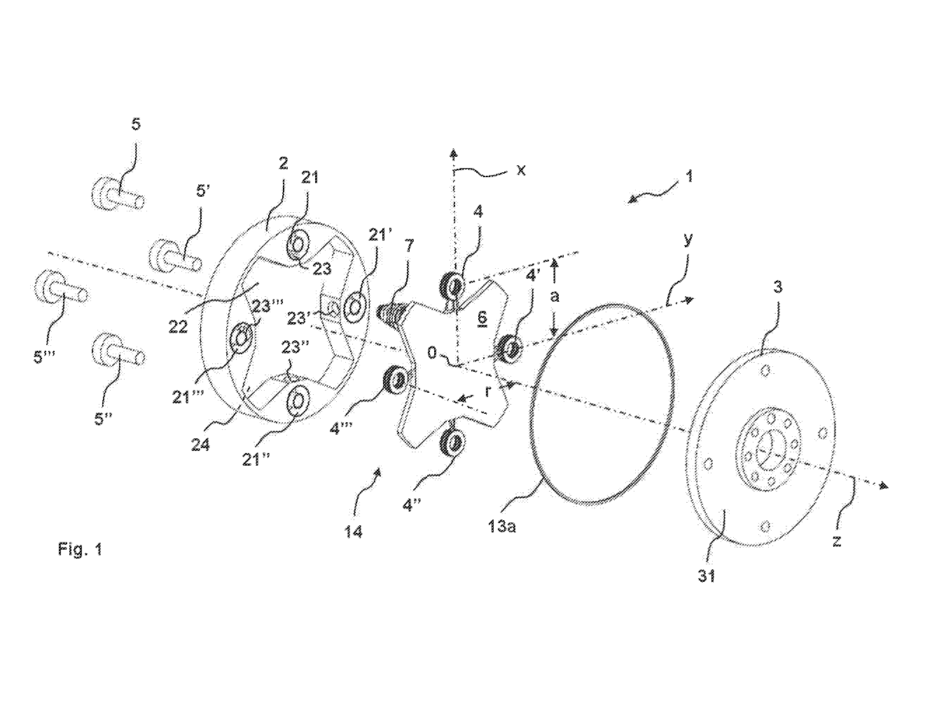

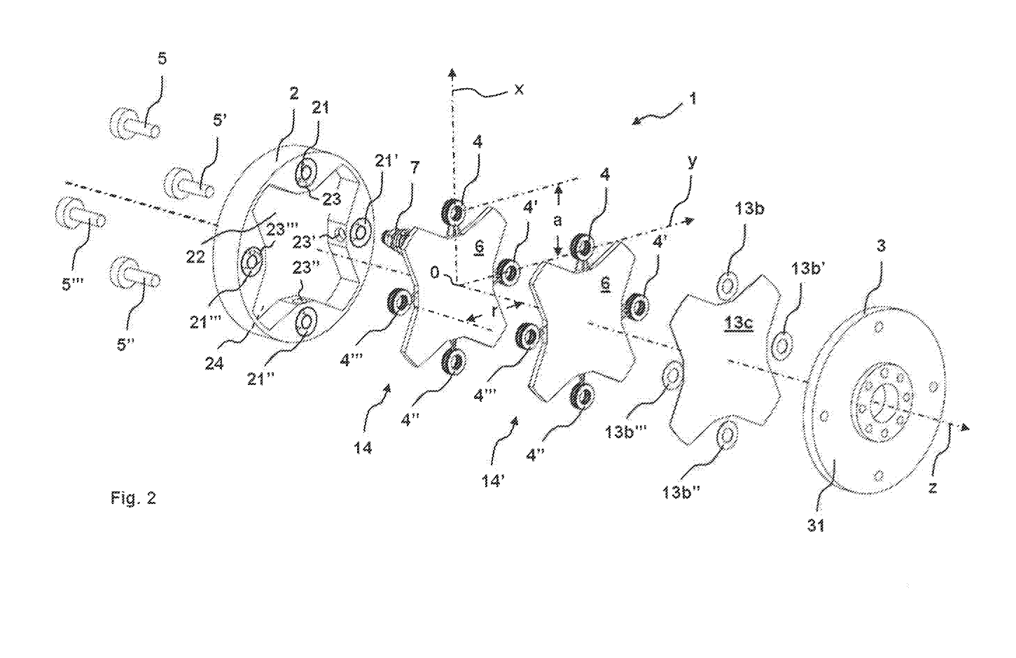

FIGS. 1 and 2 show the parts of two embodiments of a force and moment sensor 1 comprising a base plate 2 and a cover plate 3. A center 0 of the force and moment sensor 1 is located in the origin of a rectangular coordinate system having the coordinates x, y, z. The center 0 of the force and moment sensor 1 is also the center 0 of the base plate 2 and is also referred to as center 0. A direction along a z axis is also referred to as the longitudinal direction while a direction in an xy-plane is referred to as the radial direction.

Base plate 2 and cover plate 3 have greater dimensions in the xy plane than in the longitudinal direction. In the xy plane, base plate 2 and cover plate 3 have a circular cross-section of 150 mm in diameter, preferably less than/equal to 100 mm in diameter. Base plate 2 has a thickness in the longitudinal direction of 30 mm, preferably less than/equal to 20 mm. Cover plate 3 has a thickness in the longitudinal direction of 10 mm, preferably less than/equal to 5 mm. Knowing the teachings of the present invention, the base plate 2 and cover plate 3 may also have a non-circular cross section such as a polygonal cross section.

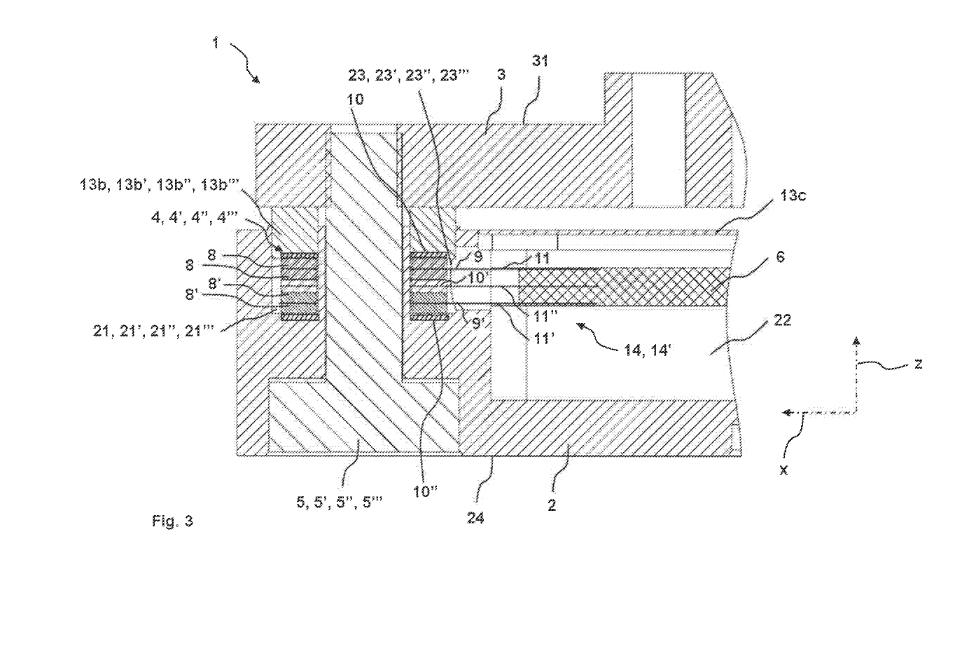

The base plate 2 is pot-shaped while the cover plate 3 is formed as a lid. A lateral edge of the base plate 2 delimits the housing in the radial direction. The lateral edge of the base plate 2 is closed without any openings. A delimiting surface 24 of the base plate 2 delimits the housing in the longitudinal direction. The delimiting surface 24 of the base plate 2 is not closed, it comprises a plurality of openings for prestressing members 5 to 5″′. A delimiting surface 31 of the cover plate 3 delimits the housing in the longitudinal direction. As shown in FIGS. 1 and 2 for example, the delimiting surface 31 of the cover plate 3 defines a plurality of openings. As shown in FIG. 3 for example, a radially outer edge of the cover plate 3 terminates just before becoming flush with the lateral edge of the base plate 2.

Base plate 2 comprises at least one chamber 21 to 21′″, and a central cavity 22. Each chamber 21 to 21′″, central cavity 22 is arranged on a side of the base plate 2 that faces the cover plate 3. Components of the force and moment sensor 1 are arranged in the chamber 21 to 21′″, and central cavity 22.

Base plate 2 and cover plate 3 are made of mechanically resistant material. Base plate 2 and cover plate 3 are mechanically connected to form a housing. The mechanical connection is performed via prestressing members 5 to 5′″ preferably in a force-fitting manner by means of screw connections. The prestressing member 5 to 5′″ may be formed as a bolt. As shown in the cross-section view of FIG. 3, cover plate 3 defines screw threads for establishing the screw connections and are accessible from a side that faces the base plate 2. Preferably, four prestressing members 5 to 5′″ extend through and protrude from four respective openings of the base plate 2 and are screwed into four respective threads of the cover plate 3. Once the prestressing members 5 to 5′″ are screwed in, the base plate 2 and the cover plate 3 are prestressed against each other. For this purpose, a bolt head of each prestressing member 5 to 5′″ rests on the base plate 2. Preferably, as shown in FIG. 3, each bolt head rests in a recess of the base plate 2 and does not protrude beyond the delimiting surface 24 of the base plate 2. The mechanical connection is gas-tight and water-tight. The gas-tight and water-tight sealing is achieved by sealing elements 13a, 13b to 13b′″, 13c. The housing protects components located in each chamber 21 to 21″′, and central cavity 22 from shocks and impacts that occur during operation. However, the housing also protects the components in each chamber 21 to 21′″, and central cavity 22 from harmful environmental conditions such as contaminants (dust, moisture, etc.). Finally, the housing protects the components in each chamber 21 to 21″′, and central cavity 22 from electric and electromagnetic interference effects in the form of electromagnetic radiation.

Preferably, the base plate 2 comprises a plurality of respective chambers 21 to 21′″ for accommodating a plurality of respective piezoelectric force transducers 4 to 4′″. Preferably, four piezoelectric force transducers 4 to 4″′ are arranged in four chambers 21 to 21″′. The center point of each chamber 21 to 21′″ that receives one of the piezoelectric force transducers 4 to 4′″ is arranged at a radial distance r with respect to the center 0. The chambers 21 to 21′″ of the piezoelectric force transducers 4 to 4′″ are also called radially spaced cavities 21 to 21′″. The center point of each of the radially spaced chambers 21 to 21′″ is arranged at the same radial distance r from the center 0. The radially spaced chambers 21 to 21′″ are identical. Each radially spaced chamber 21 to 21′″ has a circular cross section as seen in the longitudinal direction. Two radially spaced chambers 21, 21′″ are disposed so that their center points lie on the x axis and two radially spaced chambers 21′, 21′″ are disposed so that their center points lie on they axis. Two directly adjacent radially spaced chambers 21 to 21′″ are spaced apart by a distance “a” between their respective center points. Each radially spaced chamber 21 to 21′″ accommodates at least one piezoelectric force transducer 4 to 4′″. In the embodiment according to FIG. 1, each radially spaced chamber 21 to 21′″ accommodates exactly one piezoelectric force transducer 4 to 4′″. In the embodiment according to FIG. 2, each radially spaced chamber 21 to 21′″ accommodates exactly two piezoelectric force transducers 4 to 4′″, which are arranged one above the other as seen along the z axis.

Preferably, the base plate 2 defines a cavity 22 that is configured to receive therein an evaluation unit 6. The center point of the cavity 22 of the evaluation unit 6 is disposed at the center 0. The cavity 22 of the evaluation unit 6 is also called the central cavity 22. In the embodiment according to FIG. 1, the central cavity 22 accommodates exactly one evaluation unit 6. In the embodiment according to FIG. 2, the central cavity 22 accommodates exactly two evaluation units 6, which are arranged one above the other as seen along the z axis. The central cavity 22 is cross-shaped around the center 0 and comprises four legs extending in the radial direction. Two directly adjacent legs are perpendicular to each other. The four legs are offset by 45° with respect to the center 0 to the four radially spaced chambers 21 to 21″′. A radially spaced chamber 21 to 21″′ is arranged between two directly adjacent legs of the central cavity 22. This results in an optimal utilization of the available space in the base plate 2. Two directly adjacent legs contact each other in a transition region. In each transition region, the base plate 2 comprises a respective through-hole 23 to 23′″. The through-holes 23 to 23′″ of the base plate 2 are identical. Each through-hole 23 to 23′″ of the base plate 2 extends in the radial direction from the central cavity 22 to a respective radially spaced chamber 21 to 21′″. Thus, the chambers 21 to 21′″, and central cavity 22 are connected with each other via through-holes 23 to 23′″.

Preferably, as shown in FIG. 3, each piezoelectric force transducer 4 to 4′″ comprises exactly two piezoelectric transducer elements 8, 8′. Each piezoelectric transducer element 8, 8′ is disc-shaped and consists of piezoelectric material such as quartz (SiO₂ single crystal), calcium gallo germanate (Ca₃Ga₂Ge₄O₁₄ or CGG), langasite (La₃Ga₅SiO₁₄ or LGS), tourmaline, gallium orthophosphate, piezoceramics, etc. The piezoelectric force transducers 4 to 4′″ have a greater dimension in the xy plane than in the longitudinal direction. Each piezoelectric transducer element 8, 8′ has a circular cross-section of 20 mm in diameter, preferably less than/equal to 10 mm in diameter. Each piezoelectric transducer element 8, 8′ has a thickness in the longitudinal direction “Z” of less than/equal to 1.0 mm, preferably less than/equal to 0.8 mm.

The crystallographic orientation of each of the piezoelectric transducer elements 8, 8′ is such that it has a high sensitivity for a force F to be detected. Detection of the force F is dynamic with measuring frequencies in the kHz range. High sensitivity is defined as a sensitivity so that with each change in the force F the piezoelectric transducer element 8, 8′ generates as many electrical polarization charges Q as possible. The force F comprises force components Fx, Fy, Fz wherein the indices x, y, z refer to element surfaces of a piezoelectric transducer element 8, 8′ on which the force components Fx, Fy, Fz act. The indices x, y, z correspond to the coordinates x, y, z.

The force F acts on the element surfaces either as a normal force or as a shear force. A normal force acts along an effective axis that is parallel to the surface normal of the element surface. A shear force acts along an effective axis that is perpendicular to the surface normal of the element surface. For each piezoelectric transducer element 8, 8′ depicted in FIG. 3, the z axis is the surface normal. For detecting the normal force Fz, a first piezoelectric transducer element 8 has a crystallographic orientation so that electrical polarization charges Qz are generated on element surfaces that have surface normals that are parallel to the z axis of the normal force Fz. For the piezoelectric shear effect, a second piezoelectric transducer element 8′ has a crystallographic orientation so that electrical polarization charges Qx or Qy are generated on element surfaces that have surface normals that are perpendicular to the x axis of the shear force Fx or perpendicular to the y axis of the shear force Fy. For detecting the shear force Fx, the second piezoelectric transducer element 8′ is arranged with a crystallographic orientation of high sensitivity along the x axis. For detecting the shear force Fy, the second piezoelectric transducer element 8′ is arranged with a crystallographic orientation of high sensitivity along the y axis. In this manner, the same second piezoelectric transducer element 8′ can thus be arranged in the xy plane either for detecting the shear force Fx with a crystallographic orientation of high sensitivity along the x axis or for detecting the shear force Fy with a crystallographic orientation of high sensitivity along the y axis, i.e., it must only be rotated by 90°. Each piezoelectric transducer element 8, 8′ has two element surfaces. The electrical polarization charges Q on the element surfaces of each of the piezoelectric transducer elements 8, 8′ have opposite polarities. However, those skilled in the art knowing the present invention may also use a piezoelectric transducer element having a different shape. Thus, a rod-shaped piezoelectric transducer element may be used for the piezoelectric transversal effect which is cut in a crystallographic orientation so that electrical polarization charges Qz are generated on element surfaces that have surface normals that are perpendicular to the z axis of the normal force Fz.

Preferably, each piezoelectric force transducer 4 to 4″′ comprises a plurality of transducer electrodes 9, 9′ and a plurality of counter electrodes 10 to 10″. The transducer electrodes 9, 9′ and counter electrodes 10 to 10″ are made of electrically conductive material such as aluminum, copper, gold, etc., and collect the electrical polarization charges Q from the element surfaces of the piezoelectric transducer elements 8, 8′. The transducer electrodes 9, 9′ and counter electrodes 10 to 10″ lie in the xy plane and have a circular cross-section of 20 mm in diameter, preferably less than/equal to 10 mm in diameter. Transducer electrodes 9, 9′ have a thickness of less than/equal to 0.2 mm, preferably less than/equal to 0.05 mm in the longitudinal direction “Z”. Counter electrodes 10 to 10″ have a thickness of less than/equal to 2.0 mm, preferably less than/equal to 1.0 mm in the longitudinal direction “Z”. However, those skilled in the art knowing the present invention may also use counter electrodes 10 to 10″ having the same thickness as the transducer electrodes 9, 9′.

Each piezoelectric force transducer 4 to 4′″ comprises at least one first piezoelectric transducer element 8 for detecting the normal force Fz and at least one second piezoelectric transducer element 8′ for detecting the shear force Fx or Fy. The embodiment of the piezoelectric force transducer 4 to 4′″ according to FIG. 3 comprises exactly two first piezoelectric transducer elements 8 for detecting the normal force Fz and exactly two second piezoelectric transducer elements 8′ for detecting the shear force Fx or Fy. The two first piezoelectric transducer elements 8 are arranged in pairs and the two second piezoelectric transducer elements 8′ are also arranged in pairs. In the representation shown in FIG. 3, the two first piezoelectric transducer elements 8 are arranged above the two second piezoelectric transducer elements 8′ as seen along the z axis. A first transducer electrode 9 is located between element surfaces of the two first piezoelectric transducer elements 8 as seen along the z axis. A second transducer electrode 9′ is situated between element surfaces of the two second piezoelectric transducer elements 8′ as seen along the z axis. Counter electrodes 10 to 10″ rest against element surfaces of the piezoelectric transducer elements 8, 8′ that face away from the transducer electrodes 9, 9′. A first counter electrode 10 rests against an element surface that is the upper one with respect to the z axis and faces away from the first transducer electrode 9 of a first piezoelectric transducer element 8. A second counter electrode 10′ is arranged between the two first piezoelectric transducer elements 8 and the two second piezoelectric transducer elements 8′ as seen along the z axis. The second counter electrode 10′ rests against an element surface that is the lower one as seen along the z axis and faces away from the first transducer electrode 9 of a first piezoelectric transducer element 8 and rests against an element surface that is the upper one as seen along the z axis and faces away from the second transducer electrode 9′ of a second piezoelectric transducer element 8′. A third counter electrode 10″ rests against an element surface which is the lower one as seen along the z axis and faces away from the second transducer electrode 9′ of a second piezoelectric transducer element 8′.

The element surfaces resting against the transducer electrodes 9, 9′ of the piezoelectric transducer elements 8, 8′ have the same polarities and are electrically connected in parallel by the transducer electrodes 9, 9′. Furthermore, the element surfaces resting against the counter electrode 10 of the piezoelectric transducer elements 8, 8′ also have the same polarities and are electrically connected in parallel by the counter electrodes 10 to 10″. Electrical polarization charges Q having the same polarities are generated under the action of the force F on the element surfaces connected in parallel. Thus, the transducer electrodes 9, 9′ and counter electrodes 10 to 10″, respectively, sum up electrical polarization charges Q having the same polarity. Preferably, the counter electrodes 10 to 10″ are at the same ground potential as the housing of the force and moment sensor 1.

The electrical polarization charges Q of the transducer electrodes 9, 9′ and counter electrodes 10 to 10″ are received by electrical conductors 11 to 11″. Electrical conductors 11 to 11″ are wire-shaped and made of electrically conductive material such as aluminum, copper, gold, etc. A first electrical conductor 11 receives electrical polarization charges Q from the first transducer electrode 9. A second electrical conductor 11′ receives electrical polarization charges Q from the second transducer electrode 9′. A third electrical conductor 11″ receives electrical polarization charges Q from the counter electrodes 10 to 10″. The electrical polarization charges Q are transmitted to the evaluation unit 6 by the electrical conductors 11 to 11″.

Each piezoelectric force transducer 4 to 4′″ is mechanically prestressed by a respective prestressing member 5 to 5′″. The respective piezoelectric force transducer 4 to 4′″ arranged in the respective radially spaced chamber 21 to 21′″ is mechanically prestressed by the respective prestressing member 5 to 5′″ of the base plate 2 against the cover plate 3 with a prestressing force. As shown in FIGS. 1 to 3, each prestressing member 5 to 5′″ protrudes through an opening of the base plate 2 and is screwed in a thread defined by the cover plate 3. With respect to the xy plane, each opening is arranged in the center of a radially spaced chamber 21 to 21′″. Each opening in the base plate 2 is separated from the respective radially spaced chamber 21 to 21′″ by a socket defined in the base plate 2. In the prestressed state of the base plate 2 against the cover plate 3 as shown in FIG. 3, the socket is configured so that it separates the radially spaced chamber 21 to 21′″ from the prestressing member 5 to 5′″. Mechanical prestressing ensures an excellent electrical contact between the piezoelectric transducer elements 8, 8′ and the transducer electrodes 9, 9′ and counter electrodes 10 to 10″ of the piezoelectric force transducer 4 to 4′″ whereby no non-contact areas with high local electrical stresses and electric leakage currents will occur and, moreover, also surface roughnesses on the contact surfaces will be evened resulting in excellent linearity of the force and moment sensor 1. The linearity is a deviation from the proportionality between the electrical polarization charges Q and the force components Fx, Fy, Fz to be detected.

Each chamber 21 to 21″′, and central cavity 22 of the base plate 2 is sealed in a gas-tight and water-tight manner by at least one sealing element 13a, 13b to 13b′″, 13c. The sealing element 13a, 13b to 13b′″, 13c is made of plastics, metal, etc. In the embodiment according to FIG. 1, the force and moment sensor 1 comprises an annular sealing element 13a. The annular sealing element 13a is arranged between the lateral edge of the base plate 2 and the radially outer edge of the cover plate 3. The annular sealing element 13a is compressed in the prestressed state of the base plate 2 against the cover plate 3 whereby the seal is provided. In the embodiment according to FIG. 2, the force and moment sensor 1 comprises a plurality of disc-shaped sealing elements 13b to 13b′″, 13c. First disc-shaped sealing elements 13b to 13b′″ seal a plurality of radially spaced chambers 21 to 21′″. A second disc-shaped sealing element 13c provides a seal for the central cavity 22. Preferably, the disc-shaped sealing elements 13b to 13b′″, 13c contact edges of each of the chambers 21 to 21′″ and central cavity 22 by material bonding. The material bond is achieved by welding, diffusion bonding, thermocompression bonding, soldering, etc.

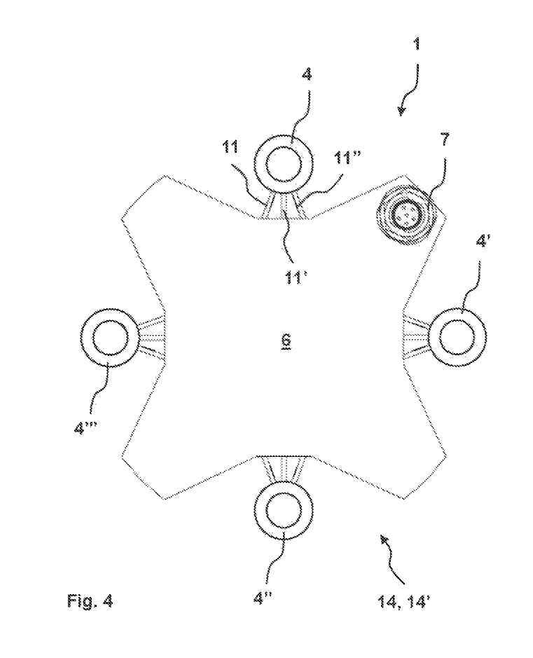

The evaluation unit 6 is mechanically connected to the base plate 2, preferably by means of a form fitting, frictional or material bonding connection. The dimension of the evaluation unit 6 in the xy plane is greater than in the longitudinal direction. The evaluation unit 6 is disc-shaped having a maximum diameter in the xy plane of less than 150 mm, preferably less than 100 mm. In the embodiments shown in FIGS. 1, 2 and 4, the evaluation unit 6 is a cross-shaped disc in the xy plane. A thickness of the evaluation unit 6 in the longitudinal direction “Z” is less than or equal to 20 mm.

The evaluation unit 6 comprises an electrical circuit board. The electrical circuit board is made of electrically insulating support material such as polytetrafluoroethylene, polyimide, Al₂O₃ ceramics, hydrocarbon-ceramic laminates, etc. The electrical circuit board is provided with electronic components such as electrical resistors, electrical capacitors, semiconductor elements, processors, etc. The electrical circuit board comprises electrical signal conductors. The electrical signal conductors are made of electrically conductive material such as pure metals, nickel alloys, cobalt alloys, iron alloys, etc. The electrical signal conductors lie flat on the support material of the electrical circuit board and provide the electrical connections between the electronic components. The electrical conductors 11 to 11″ of the piezoelectric force transducers 4 to 4′″ are guided to the electrical circuit board. The electrical conductors 11 to 11″ of one piezoelectric force transducer 4 to 4′″ extend from the radially outer chamber 21 to 21″′ of the piezoelectric force transducer 4 to 4′″ through a respective through-hole 23 to 23′″ of the base plate 2 into the central cavity 22 of the base plate 2. In the central cavity 22, ends of the electrical conductors 11 to 11″ are in electrical contact with electrical signal conductors on a surface of the electrical circuit board opposite of the lower delimiting surface 24. In the central cavity 22, the electrical conductors 11 to 11″ are easily accessible for a tool for contacting. Preferably, the electrical conductors 11 to 11″ contact the electrical signal conductors by material bonding. The material bond is achieved by welding, diffusion bonding, thermocompression bonding, soldering, etc. In this way, through-holes 23 to 23′″ of the base plate 2 enable simple, rapid and secure electrical contacting of the electrical conductors 11 to 11″ of a piezoelectric force transducer 4 to 4′″ to the electrical circuit board of the evaluation unit 6.

The electronic components of the evaluation unit 6 include at least one charge amplifier and at least one analog-to-digital converter. Preferably, the evaluation unit 6 comprises at least one charge amplifier and at least one analog-to-digital converter for each piezoelectric force transducer 4 to 4′″. The evaluation unit 6 analyzes the measurement signals of the piezoelectric force sensors 4 to 4″′. A first charge amplifier amplifies electrical polarization charges Q from the first piezoelectric transducer element 8 and a first analog-to-digital converter digitizes the amplified electrical polarization charges Q from the first piezoelectric transducer element 8. A second charge amplifier amplifies electrical polarization charges Q from the second piezoelectric transducer element 8′ and a second analog-to-digital converter digitizes the amplified electrical polarization charges Q from the second piezoelectric transducer element 8′.

Four piezoelectric force transducers 4 to 4′″ each are in electrical contact to an evaluation unit 6 via electrical conductors 11 to 11″ and form a force transducer module 14, 14′. In the embodiment according to FIG. 1, the force and moment sensor 1 comprises one force transducer module 14 while in the embodiment according to FIG. 2 the force and moment sensor 1 comprises two force transducer modules 14, 14′. The dimension of one force transducer module 14, 14″ in the longitudinal direction “Z” is so small as compared to the base plate 2 that it is possible to arrange two force transducer modules 14, 14′ on top of each other in the base plate 2 in the longitudinal direction.

Therefore, base plate 2 and cover plate 3 may have the same dimensions for both embodiments of the force and moment sensor 1. The thickness of the counter electrodes 10 to 10″ in the longitudinal direction “Z” will be adjusted to accommodate the number of piezoelectric force transducers 4 to 4′″ arranged in each radially spaced chamber 21 to 21′″. If the force and moment sensor 1 comprises only one force transducer module 14, then only one piezoelectric force transducer 4 to 4′″ will be arranged in each radially spaced chamber 21 to 21′″. Then, in order for the force to be detected to act onto the piezoelectric force transducers 4 to 4′″, the thickness in the longitudinal direction “Z” of the counter electrodes 10 to 10″ is such that the radially spaced chambers 21 to 21′″ become completely filled. If the force and moment sensor 1 comprises two force transducer modules 14, 14′, each radially spaced chamber 21 to 21′″ will house two piezoelectric force transducers 4 to 4′″ of each force transducer module 14, 14′ that are arranged one on top of the other and are at the same ground potential via counter electrodes 10 to 10″. Thus, for the force to be detected to act on the piezoelectric force transducers 4 to 4″′, the counter electrodes 10 to 10″ will be so thin in the longitudinal direction “Z” that the radially spaced chambers 21 to 21′″ become completely filled. Two evaluation units 6 of the force transducer modules 14, 14′ are arranged in the central cavity 22 one on top of the other at a spatial distance from each other. The two force transducer modules 14, 14′ detect the same force independently of each other. The two force transducer modules 14, 14′ evaluate measurement signals independently of each other.

For the embodiment of a force and moment sensor 1 according to FIGS. 1 and 2, the evaluation unit 6 is able to calculate three components Fx, Fy, Fz of a force F and three components Mx, My, Mz of a moment M from the digitized electrical polarization charges Qx to Qx′″, Qy to Qy″′ Qz to Qz″′ of the eight piezoelectric force sensors 4 to 4″′. The respective equations are:

Fx=+Qx′−Qx″

Fy=+Qy″−Qy

Fz=+Qz+Qz′+Qz″+Qz′″

Mx=a/2*(+Qz+Qz′)−a/2*(+Qz″+Qz″)

My=a/2*(+Qz′+Qz″)−a/2*(+Qz+Qz″′)

Mz=a/2*(+Qy+Qx′+Qy″+Qx′″)

For the three calculated components Fx, Fy, Fz of the force F and the three calculated components Mx, My, Mz of the moment M, the evaluation unit 6 generates and provides digital output signals. The digital output signals of six components can describe a triaxial joining force.

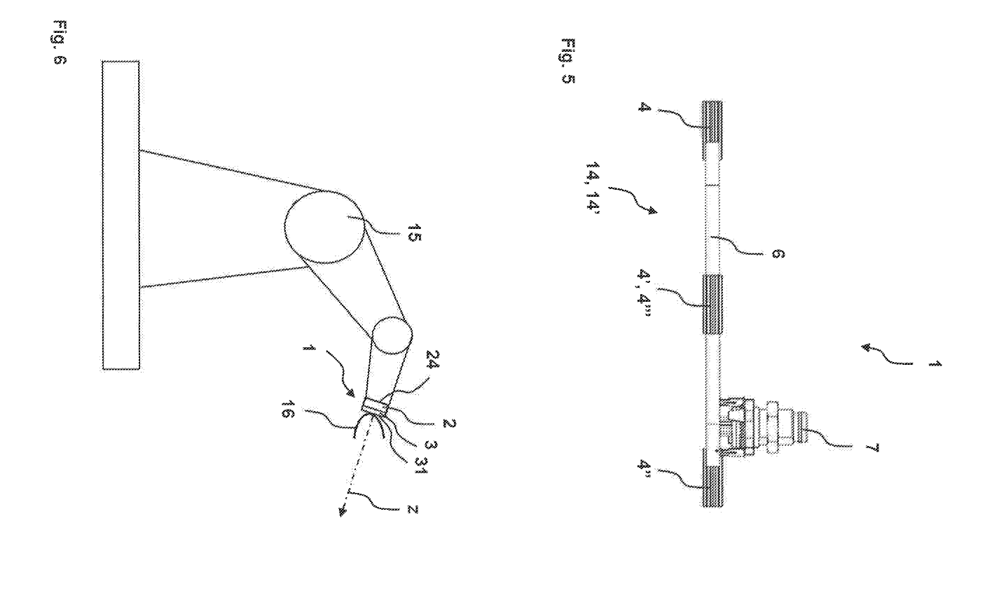

Evaluation unit 6 comprises an interface socket 7 as shown in FIGS. 1, 2, 4 and 5. An interface connector of a bus system such as Ethercat, Ethernet Powerlink, etc. may be electrically connected at the interface socket 7. The interface connector and the bus system are not shown in FIG. 1 or FIG. 2. Via the bus system, the evaluation unit 6 communicates with a robot control of the robot and sends the provided digital output signals to the robot control of the robot. The communication is real-time communication with a bus rate of at least 1 kHz, preferably of at least 4 kHz. Bus rate and measuring frequency are selected in a way that the measuring frequency is greater than the bus rate.

FIG. 6 shows a portion of an embodiment of a robot 15 with a force and moment sensor 1. Robot 15 comprises a robot arm. The robot arm is adapted to perform complex operations such as the joining of components. The force and moment sensor 1, 1′ is arranged in a wrist of a robot arm. The delimiting surface 24 of the base plate 2 of the force and moment sensor 1 is mechanically connected to a surface of the wrist of the robot 15. Preferably, the mechanical connection is achieved in a force fitting manner by means of screw connections. A tool 16, which the robot 15 uses to carry out complex machining or also simple operations, is mechanically connected to the delimiting surface 31 of the cover plate 3 of the force and moment sensor 1. The mechanical connection is preferably achieved in a force fitting manner by means of screw connections.

The tool 16 may form a lever arm on which a force F acts which leads to a bending moment acting on the delimiting surface 31 of the cover plate 3 of the force and moment sensor 1 along the z axis as a normal force. This normal force acts parallel to the prestressing force of the piezoelectric force transducers 4 4′″.

The force and moment sensor 1 may detect the force F in a redundant manner. As shown in the embodiment of the force and moment sensor 1 according to FIG. 2, two force transducer modules 14, 14′ comprising two times four piezoelectric force transducers 4 to 4′″ are arranged in four chambers 21 to 21′″ of the base plate 2 for this purpose. A first force transducer module 14 comprises first piezoelectric force sensors 4 to 4′″ detecting a force F a first time and generating first measurement signals for the force F detected a first time. A second force transducer module 14′ comprises second piezoelectric force transducers 4 to 4′″ detecting the same force F a second time and generating second measurement signals for the force F detected a second time. This redundant detection of the force by means of two force transducer modules 14, 14′ is carried out simultaneously. The force transducer modules 14, 14′ detect the same force independently of each other. Each force transducer module 14, 14′ comprises an evaluation unit 6. Two evaluation units 6 of the two force transducer modules 14, 14′ are arranged in the central cavity 22. The first measurement signals corresponding to the force F detected a first time are transmitted via electrical conductors 11 to 11″ to a first evaluation unit 6 of the first force transducer module 14. The second measurement signals of the force F detected a second time are transmitted via electrical conductors 11 to 11″ to a second evaluation unit 6 of the second force transducer module 14′. The first evaluation unit 6 analyzes the first measurement signals of the force F detected a first time and provides first digital output signals therefor. The second evaluation unit 6 analyzes the second measurement signals of the force F detected a second time and provides second digital output signals therefor. The force transducer modules 14, 14′ evaluate the measurement signals of the force F detected a first time and the force F detected a second time independently of each other.

The force and moment sensor 1 transmits the first digital output signals of the force F detected a first time and the second digital output signals of the force F detected a second time via the bus system to the robot control of the robot 15. The robot control may compare the transmitted first digital signals output signals of the force F detected a first time to the transmitted second digital output signals of the force detected a second time.

### LIST OF REFERENCE NUMERALS

0 center of the force and moment sensor
1 force and moment sensor
2 base plate
3 cover plate
4 to 4′″ piezoelectric force transducer
5 to 5′″ prestressing member
6 evaluation unit
7 interface socket
8, 8′ piezoelectric transducer element
9, 9′ transducer electrode
10 to 10″ counter electrode
11 to 11″ electrical conductors
13a, 13b to 13b′″, 13c sealing element
14, 14′ force transducer module
15 robot
16 tool
21 to 21′″ radially outer chamber
22 central cavity
23 to 23′″ through-hole
24 delimiting surface of base plate
31 delimiting surface of cover plate
a distance
r radial distance
x, y, z coordinates

1. A force and moment sensor comprising:
four piezoelectric force transducers that are configured to detect a force and generate measurement signals for the detected force;
a cover plate that defines a delimiting surface on which the force to be detected acts;
an evaluation unit that is electrically connected to the piezoelectric force sensors and configured to evaluate the measurement signals;
a base plate that defines a cavity in which the piezoelectric force transducers and the evaluation unit are arranged; and
wherein the base plate and cover plate are mechanically connected to form a housing.

2. The force and moment sensor according to claim 1, wherein the four piezoelectric force transducers are in electrical contact to the evaluation unit via electrical conductors to form a force transducer module.

3. The force and moment sensor according to claim 2, wherein a second force transducer module is arranged in the cavity of the base plate.

4. The force and moment sensor according to claim 1, wherein each piezoelectric force transducer is arranged in the cavity radially spaced apart from a center of the base plate; and wherein the evaluation unit is arranged in the cavity in the center of the base plate.

5. The force and moment sensor according to claim 4, wherein with respect to the center of the base plate the cavity of the evaluation unit is cross-shaped and comprises four legs, which legs extend in a radial direction; and wherein a cavity of a piezoelectric force transducer is arranged between two directly adjacent legs.

6. The force and moment sensor according to claim 5, wherein two directly adjacent legs meet in a respective transition region; wherein the base plate defines a through-hole in each respective transition region; and wherein each through-hole extends in the radial direction from the cavity of the evaluation unit to a respective cavity of a piezoelectric force transducer.

7. The force and moment sensor according to claim 1, wherein each piezoelectric force transducer comprises a plurality of piezoelectric transducer elements; wherein each piezoelectric force transducer detects exactly one component of a normal force by a first piezoelectric transducer element; and wherein each piezoelectric force transducer detects exactly one component of a shear force by a second piezoelectric transducer element.

8. The force and moment sensor according to claim 7, wherein each piezoelectric force transducer comprises a plurality of transducer electrodes, which are configured to collect electrical polarization charges as measurement signals from an element surface of a piezoelectric transducer element; wherein each piezoelectric force transducer comprises a plurality of counter electrodes, which are configured to collect electrical polarization charges as measurement signals from an element surface of a piezoelectric transducer element.

9. The force and moment sensor according to claim 8, wherein each piezoelectric force transducer comprises exactly three electrical conductors; wherein a first transducer electrode rests against at a first element surface of a first piezoelectric transducer element; wherein the first transducer electrode is in electrical contact with a first electrical conductor; wherein a second transducer electrode rests against an element surface of a second piezoelectric transducer element; the second transducer electrode is in electrical contact with a second electrical conductor; wherein counter electrodes rest against the element surfaces of the piezoelectric transducer elements opposite of the transducer electrodes; and wherein the counter electrodes are in electrical contact with a third electrical conductor.

10. The force and moment sensor according to claim 1, wherein the evaluation unit comprises an electrical circuit board that includes support material, electronic components and electrical signal conductors; wherein each piezoelectric force transducer includes transducer electrodes and transducer counter electrode and comprises exactly three electrical conductors in electrical contact with the transducer electrodes and the transducer counter electrodes of the respective piezoelectric force transducer; wherein the three electrical conductors extend through a through-hole of the base plate from a cavity of a piezoelectric force transducer to the cavity of the evaluation unit; and that the three electrical conductors are in electrical contact with electrical signal conductors of the evaluation unit on one side of the electrical circuit board.

11. The force and moment sensor according to claim 10, wherein the evaluation unit analyzes measurement signals of the piezoelectric force transducers and provides them as digital output signals; that the evaluation unit comprises at least one interface socket, to which interface socket an interface plug of a bus system can be electrically connected; and that the evaluation unit transmits digital output signals provided via the bus system to a robot control of a robot.

12. A robot comprising:
four first piezoelectric force transducers configured for detecting a force and generating measurement signals for the detected force;
a second evaluation unit that is electrically connected to the first piezoelectric force sensors and configured to evaluate the measurement signals;
a cover plate that defines a delimiting surface on which the force to be detected acts;
a base plate that defines a cavity in which the first piezoelectric force transducers and the first evaluation unit are disposed, wherein the base plate further defines a delimiting surface;
wherein the base plate and cover plate are mechanically connected to form a housing;
a tool;
a wrist defining a surface thereof;
wherein the delimiting surface of the base plate sensor is mechanically connected to the surface of the wrist; and
wherein the delimiting surface of the cover plate is mechanically connected to the tool.

13. The robot according to claim 12, wherein each first piezoelectric force transducer is mechanically prestressed with a prestressing force against the delimiting surface of the cover plate, wherein an effective direction of the prestressing force is normal to the delimiting surface; and wherein a bending moment of the tool acts as a normal force on the first piezoelectric force transducers.

14. The robot according to claim 12, further comprising:
a second evaluation unit and four second piezoelectric force transducers in electrical contact to the second evaluation unit via electrical conductors to form a second force transducer module;
wherein the first four piezoelectric force transducers are in electrical contact to the evaluation unit via electrical conductors to form a first force transducer module;
wherein the first piezoelectric force transducers of the first force transducer module are configured to detect a force a first time and generate first measurement signals for the force detected a first time; and wherein the second piezoelectric force transducers of the second force transducer module detect the same force a second time and generate second measurement signals for the force detected a second time.

15. The robot according to claim 14, further comprising:
a robot control;
a bus system connected to the robot control;
wherein a first evaluation unit of the first force transducer module is configured to evaluate the first measurement signals and generate first digital output signals;
wherein a second evaluation unit of the second force transducer module is configured to evaluate the second measurement signals and generate second digital output signals;
wherein the first force transducer module is configured to transmit the first digital output signals via the bus system to the robot control;
wherein the second force transducer module is configured to transmit the second digital output signals via the bus system to the robot control of the robot; and
wherein the robot control is configured to compare the transmitted first digital output signals to the transmitted second digital output signals.
